(19) United States
(12) Patent Application Publication
(10) Pub. No.: US 2026/0233444 A1
(43) Pub. Date: Aug. 13, 2026

(54) COMPOSITE ARTICLES AND METHODS OF MANUFACTURING COMPOSITE ARTICLES

(71) Applicant: PepsiCo, Inc., Purchase, NY (US)

(72) Inventor: Girish DESHPANDE, Carmel, NY (US)

(21) Appl. No.: 19/051,954

(22) Filed: Feb. 12, 2025

(51) Int. Cl. B29C 45/14; B29C 45/56; B29K 105/00; B29K 705/02; B29K 709/08; B29L 22/00

(52) U.S. Cl. CPC B29C 45/14336; B29C 45/561; B29C 2945/76498; B29C 2945/76531; B29K 2105/0067; B29K 2105/253; B29K 2705/02; B29K 2709/08; B29L 2022/00

(57) ABSTRACT

A process for manufacturing a composite article includes forming a base component of a base material and forming a structure on the base component by applying a fluid mixture to the base component. Applying the fluid mixture to the base component includes forcing the fluid mixture into a mold cavity in which the base component is disposed. The fluid mixture includes molten plastic and an additive that is reactive with the base material.

### BACKGROUND

Plastics have multiple characteristics making them useful in packaging, such as light weight, formability, barrier properties, and durability. However, various factors have led both packagers and consumers to take measures to reduce plastic usage.

One measure to reduce plastic usage is to use packaging constructed of material other than plastic. Metal is one such alternative packaging material. Metal packaging can also be light in weight and durable, and can also have good barrier properties. However, while many metal forming processes exist, some structures remain more costly to create from metal than from plastic.

Glass is another alternative packaging material. Glass has good barrier properties and is safe for contact with a wide variety of products, but is relatively heavy and fragile.

### BRIEF SUMMARY

Difficulties associated with non-plastic materials such as metal and glass can be mitigated by creating composite articles that include both the non-plastic material and a plastic structure. The plastic structure can be used to reinforce the article or provide certain shapes that are difficult to form in the non-plastic material. For example, a composite container may be created by forming a threaded plastic structure on a metal vessel, which may reduce costs relative to all-metal containers with threaded closures by enabling the composite container to be constructed and handled with little modification to readily available facilities for canning or plastic bottles. In another example, plastic can be used to reinforce glass vessels, enabling construction of composite containers having a significantly smaller total weight than all-glass containers.

When forming such composite articles, plastic can be applied to the non-plastic component in a manner that creates a bond between the plastic component and the non-plastic component. For example, a reactive additive can be included in either component to react with the other component and create a chemical bond between the components. In some further examples, the plastic component can be created by applying a mixture to the non-plastic component, with the mixture including an additive that is reactive with material in the non-plastic component. Such additives can include substances that oxidize metal or glass. In some further examples, an additive can be integrated into the non-plastic component, with the additive of the non-plastic component being reactive with material in the plastic component.

While some examples of composite articles described herein are composite containers, the concepts of the present disclosure can be applied in the creation of any type of composite article.

Some aspects of the present disclosure relate to a method of manufacturing a bottle. The method may include forming a vessel of metal and forming a structure on the vessel by applying a fluid mixture to the vessel. The fluid mixture may include a molten substance and an additive. The molten substance may be a plastic. The additive may be reactive with the metal such that the additive reacts with the metal to form a bond layer joining the structure to the vessel.

In some embodiments according to the foregoing, the structure may include a threaded fitment.

In some embodiments according to any of the foregoing, the method may include assembling a cap onto the fitment.

In some embodiments according to any of the foregoing, the bond layer may be formed across an entirety of a surface area of the vessel contacted by the fluid mixture.

In some embodiments according to any of the foregoing, the method may include applying the fluid mixture to the vessel at a temperature and pressure sufficient to initiate a chemical reaction between the additive and the metal.

In some embodiments according to any of the foregoing, the chemical reaction may include oxidation of the metal.

In some embodiments according to any of the foregoing, the chemical reaction may create a chemical bond between the structure and the vessel.

In some embodiments according to any of the foregoing, the additive may include a substance selected from a group consisting of a hydroxyl group containing compound, carboxylic acid, a hindered amine light stabilizer, an acrylate containing substance, a phenolic substance, and erucamide.

Some aspects of the present disclosure relate to a method of manufacturing a composite container. The method may include forming a vessel of glass. The vessel may define an interior space and include an outer surface that faces away from the interior space. The method may also include forming a coating on the vessel by applying a fluid mixture to the outer surface. The fluid mixture may include a molten substance and an additive. The molten substance may be a plastic and the additive may be reactive with the glass such that the additive reacts with the metal to form a bond layer joining the coating to the vessel.

In some embodiments according to the foregoing, the glass may include silica, soda ash, lime and alumina.

In some embodiments according to any of the foregoing, the method may include applying the fluid mixture to the vessel at a temperature and pressure sufficient to initiate a chemical reaction between the additive and the glass.

In some embodiments according to any of the foregoing, the chemical reaction may include oxidation of the glass.

In some embodiments according to any of the foregoing, the chemical reaction may create a chemical bond between the structure and the vessel.

In some embodiments according to any of the foregoing, the additive may include a substance selected from a group consisting of a metal oxide, a salt, and an isolated element capable of bonding to glass.

In some embodiments according to any of the foregoing, the method may include causing the fluid mixture to spread across and solidify upon a majority of the outer surface to create the composite container.

In some embodiments according to any of the foregoing, no more than 1.0% of the composite container by weight includes plastic.

In some embodiments according to any of the foregoing, applying the fluid mixture to the vessel may include compressing the glass of the vessel by application of the fluid mixture.

In some embodiments according to any of the foregoing, the vessel may include an inner surface that defines the interior space. The method may include allowing the fluid mixture to solidify on the vessel to create the composite container. The method may also include keeping the inner surface of the vessel free of the fluid mixture and coating such that no portion of the coating adjoins the interior space in the composite container.

In some embodiments according to any of the foregoing, the additive may be a first additive. The vessel may include a second additive integrated into the glass. The second additive may be reactive with the first additive.

Some aspects of the present disclosure relate to a composite article including a vessel formed of a base material. The base material may include metal or glass. The composite article may also include a structure formed on the vessel. The structure may include plastic. The structure may also include a bond layer joining the structure to the vessel. The bond layer may include a product of a chemical reaction between the base material and a substance comprised by the structure.

In some embodiments according to the foregoing, the product of the chemical reaction may include an oxide of the base material.

In some embodiments according to any of the foregoing, the substance may be an additive selected from a group consisting of a hydroxyl group containing compound, carboxylic acid, a hindered amine light stabilizer, an acrylate containing substance, a phenolic substance, and erucamide, or an additive selected from a group consisting of a metal oxide, a salt, and an isolated element capable of bonding to glass.

In some embodiments according to any of the foregoing, the vessel may be a metal bottle.

In some embodiments according to any of the foregoing, the vessel may be a glass jar.

### BRIEF DESCRIPTION OF THE DRAWINGS

FIG. 1 illustrates a composite article according to some aspects of the present disclosure.

FIG. 2 illustrates a base component in a mold according to some aspects of the present disclosure.

FIG. 3A is a cross-sectional view of a composite article according to some aspects of the present disclosure.

FIG. 3B is an enlarged view of a portion of the composite article of FIG. 3A.

FIG. 4 is a flowchart of a manufacturing process for a composite article according to some aspects of the present disclosure.

FIG. 5 is a cross-sectional, cut-away view of a portion of a base component in a portion of a mold according to some aspects of the present disclosure.

FIG. 6A is a cross-sectional, cut-away view of a portion of a composite article according to some aspects of the present disclosure.

FIG. 6B is an enlarged view of a portion of the composite article of FIG. 6A.

FIG. 7 is a cross-sectional view of a closed composite container including the composite article of FIG. 6A.

FIG. 8 is a cross-sectional view of a base component in a mold according to some aspects of the present disclosure.

FIG. 9A a cross-sectional view of a composite article according to some aspects of the present disclosure.

FIG. 9B is an enlarged view of a portion of the composite article of FIG. 9A.

FIG. 10 is a cross-sectional view of a closed composite container including the composite article of FIG. 9A.

FIG. 11 is a flowchart of a manufacturing process for a composite container according to some aspects of the present disclosure.

### DETAILED DESCRIPTION

The present invention will now be described in detail with reference to embodiments thereof as illustrated in the accompanying drawings. References to “one embodiment,” “an embodiment,” “some embodiments,” etc., indicate that the embodiment described may include a particular feature, structure, or characteristic, but every embodiment described may not necessarily include that particular feature, structure, or characteristic. Similarly, other embodiments may include additional features, structures, or characteristics. Moreover, such phrases are not necessarily referring to the same embodiment. When a particular feature, structure, or characteristic is described in connection with the embodiment, it is submitted that it is within the knowledge of one skilled in the art to effect such feature, structure, or characteristic in connection with other embodiments whether or not explicitly described.

The terms “invention,” “disclosure,” or “present disclosure” as used herein are non-limiting terms and are not intended to refer to any single embodiment of the particular invention but encompasses all possible embodiments as described in the application.

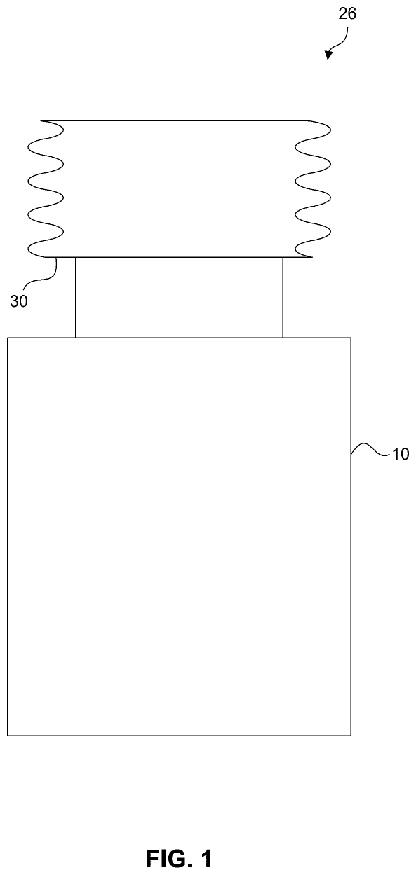

FIG. 1 shows an example of a composite article 26 according to some aspects of the present disclosure. Composite article 26 includes a base component 10 and a structure 30 formed on the base component 10. Structure 30 may be formed on base component 10 in a manner that results in structure 30 being bonded to base component 10. Structure 30 may further be formed on base component in a manner that results in structure 30 being bonded to base component 10 without use of an adhesive distinct from the materials used to form base component 10 and structure 30.

The bond between base component 10 and structure 30 may be a chemical bond.

Structure 30 may be formed of a different material or mixture of materials than base component. Thus, structure 30 may have different properties than base component 10. Composite article 26 may therefore be designed such that base component 10 and structure 30 are located where the properties of their respective materials are most advantageous. Composite article 26 may further be designed to use a minimum amount of the material of base component 10 or structure 30 needed to obtain the benefits of that material where needed. For example, structure 30 may be formed of a material that is particularly useful for certain purposes, but is also relatively costly, difficult to recycle, or otherwise undesirable to use in large quantities. Composite article 26 may be designed with structure 30 having the minimum volume necessary to fulfill its purpose so that composite article 26 may obtain the benefits of the material of structure 30 while using as little of that material as possible.

Processes of creating a composite article 26 are described herein. Composite articles 126, 226, 326 described below are provided as non-limiting examples of composite articles according to the general principles of composite article 26. Thus, the processes for forming composite articles 126, 226, 326 may be similar to the process for forming composite article 26.

Composite article 26 of the illustrated example is a bottle. Base component 10 provides a body of the bottle while structure 30 provides a finish of the bottle. However, other examples of composite articles according to the present disclosure can be other types of articles, such as various types of containers, dishware, decorations, tools, appliances, or any other article of manufacture.

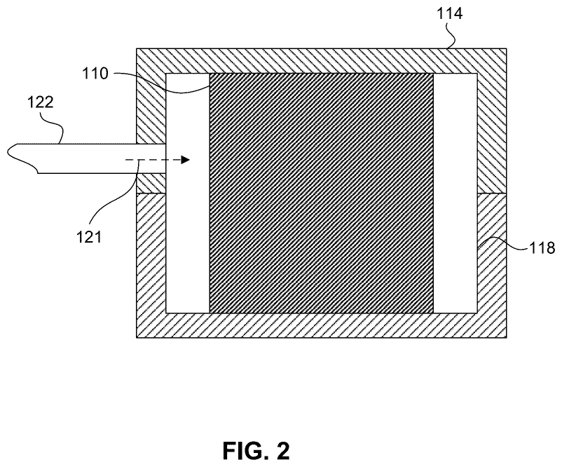

FIG. 2 shows a stage in a manufacturing process for a composite article according to some aspects of the present disclosure. As shown in FIG. 2, a base component 110 is disposed inside a mold 114. Base component 110 and mold 114 are both shown schematically and in cross-section. Mold 114 defines a mold cavity 118. Base component 110 is disposed inside mold cavity 118. A channel 122 is in fluid communication with mold cavity 118 so that substances may be forced into mold cavity 118 through channel 122. Structures may therefore be formed on base component 110 by forcing substances through channel 122 into mold cavity 118 while base component 110 remains disposed in mold cavity 118.

Base component 110 includes a base material. The base material may be a material that is not a plastic, as the term “plastic” would be commonly understood in the fields of manufacturing and packaging. Thus, the base material may be free of synthetic or semi-synthetic, polymer-based substances such as polyethylene terephthalate (“PET”), polyvinyl chloride (“PVC”), polypropylene (“PP”), and polystyrene (“PS”). The base material may include, for example, metal or glass. In further embodiments, the base material may be metal or glass.

The base material may form a majority of base component 110 by weight. In some further embodiments, the base material may form at least 95% of the base component by weight. In some further embodiments, the base material may form an entirety of base component 110.

Accordingly, in some embodiments, base component 110 may be less than half plastic by weight. In some further embodiments, base component 110 may be less than 5% plastic by weight. In some further embodiments, base component 110 may be entirely free of plastic.

In embodiments wherein base component 110 is to be integrated into a composite container, base component 110 may be a vessel formed of the base material. Composite article 26 described above and illustrated in FIG. 1 is an example of such a vessel.

A structure may be formed on base component 110 by applying a fluid mixture 121 to the base component 110. Fluid mixture 121 may include molten substance and an additive. The additive may be reactive with the base material. In some embodiments, the molten substance may include plastic. In some embodiments, the plastic may include, for example, polyethylene terephthalate (“PET”), polyvinyl chloride (“PVC”), polypropylene (“PP”), polystyrene (“PS”), or any combination thereof. Suitable additives include, for example, hydroxyl groups (in Butylated Hydroxyl Toluene (“BHT”) and phenolic antioxidants, hindered amine light stabilizers (e.g. Tinuvin and Lignostab hindered amine light stabilizers for polyolefins), slip agents (e.g. erucamide, oleomide, etc.), and blooming agents (e.g. halogen containing flame retardants and phosphate based flame retardants added to PS. The amount of additive included in fluid mixture 121 may vary depending on the additive used and the properties desired for the finished article. For example, in a fluid mixture 121 including a molten substance and an additive that differs from the molten substance, the additive may be from 1.5% to 49% of fluid mixture 121 by weight.

Fluid mixture 121 may be applied to the base component 110 at a temperature and pressure sufficient to initiate a chemical reaction between the additive and the base material.

In some embodiments, the melt temperature of the molten substance in fluid mixture 121 is sufficient to initiate a chemical reaction between the additive and the base material. Accordingly, in some embodiments, fluid mixture 121 may be applied to base component 110 at a temperature equal to or greater than the melt temperature of the molten substance. In some further embodiments, fluid mixture 121 may be applied to base component 110 at a temperature that is also below a burning or evaporation temperature of the molten substance. In some further embodiments, fluid mixture 121 may be applied to base component 110 at a temperature that is equal to or greater than the melt temperature of the additive. An appropriate temperature for fluid mixture 121 when applied to base component 110 may therefore depend on the materials used in fluid mixture 121. For example, typical melt temperatures of polyolefins range from 160° C. to 220° C. In another example, typical melt temperatures of PET range from 270° C. to 300°C.

The pressure sufficient to initiate a chemical reaction between the additive and the base material may also depend on the materials used in fluid mixture 121 and base component 110. A sufficient temperature may be, for example, from 50 tons to 1000 tons.

Optionally, the chemical reaction may include oxidation of the base material. Thus, some processes described herein may leverage properties of base materials that were previously seen as disadvantageous, such as reactivity or susceptibility to oxidation, to create secure bonds in composite articles. However, chemical reactions suitable for this aspect of the present disclosure are not limited to oxidation reactions.

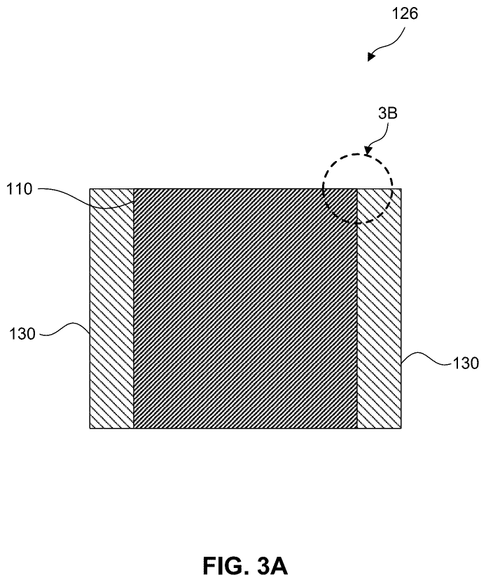

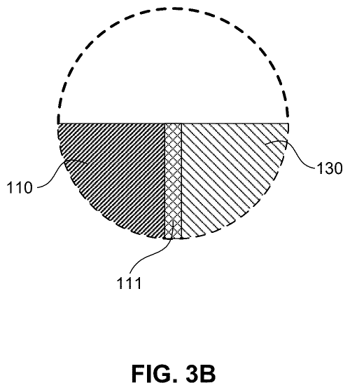

FIGS. 3A and 3B illustrate a composite article 126 formed by allowing fluid mixture 121 to solidify into a structure 130 on base component 110. Structure 130 may be formed of a different material or mixture of materials than base component 110. Structure 130 may be chemically bonded to the base component 110 by the reaction between the additive and the base material. Thus, a bond layer 111 including a product of the reaction between the additive and the base material may be formed at an interface between base component 110 and structure 130. In some embodiments, bond layer 111 may form on a majority of a surface area of base component 110 contacted by fluid mixture 121. In some embodiments, bond layer 111 may form on an entirety of a surface area of base component 110 contacted by fluid mixture 121.

Because bond layer 111 may result from an oxidation reaction, bond layer 111 may include oxide of the base material. Because the base material may include metal or glass, bond layer 111 may include metal oxide or a product of oxidizing glass. For example, where the base material includes aluminum, bond layer 111 may include alumina.

The chemical bond within bond layer 111 may provide a stronger connection between base component 110 and structure 130 than a purely mechanical connection between an otherwise identical base component 110 and structure 130. The use of an additive to create bond layer 111 therefore alleviates the need to design features into base component 110 to mechanically interlock with structure 130. The use of an additive to create bond layer 111 similarly alleviates the need to force the fluid precursor to structure 130 into mold cavity 118 under conditions optimized for mechanically interlocking structure 130 with base component 110. Using an additive to create bond layer 111 therefore increases freedom in designing base component 110 and selecting parameters for the creation of structure 130, which can improve manufacturing efficiency, reduce manufacturing costs, and allow other objectives to be prioritized. The chemical bond within bond layer 111 may also provide a bond comparable to, or even better than, a bond achievable by using an adhesive or other intervening material. Some processes according to the present disclosure may therefore eliminate the need for adhesives in the creation of composite articles. The reduction or elimination of adhesives can make manufacture of such articles simpler, less expensive, and more environmentally friendly. The reduction or elimination of adhesives can also reduce complexity of designs for articles and improve the consistency and precision of manufacturing processes for those articles. Reducing or eliminating adhesives can be particularly useful in the manufacture of containers for food because some adhesives are not food safe.

In some embodiments, composite article 126 may be a composite container. In some such embodiments, base component 110 may be a vessel formed of the base material.

“Metal” is used herein as it would be understood by a person of ordinary skill in the relevant art, and therefore encompasses alloys in addition to isolated metals. Thus, in some embodiments, the base material used for any base components described herein may include steel, such as stainless steel, as well as any aluminum based alloys known for use in beverage cans or similar products, such as aluminum alloy 3004.

In embodiments wherein the base material includes metal, the additive included in fluid mixture 121 may include a substance that is reactive with the metal of the base material. In some embodiments, the additive may include a substance that oxidizes the metal of the base material.

In some embodiments wherein the base material includes metal, the additive of fluid mixture 121 can include a hydroxyl group containing compound, carboxylic acid, or compounds with amino or acrylate groups, which can chemically bond with metal articles made up of aluminum, steel, chrome coated metal parts, metal alloys, and tin and its alloys. In a further example wherein the base material includes metal, the additive of fluid mixture can include one or more hindered amine light stabilizers. Further examples of additives suitable for bonding to metal base materials include small molecular additives, including acrylate-containing small molecule substances, phenolic substances such as BHT, amine additives such as hindered amine light stabilizers, or fatty acid ester amides such as erucamide. Thus, in some embodiments, the second additive may include at least one selected from a group consisting of a hydroxyl group containing compound, carboxylic acid, a hindered amine light stabilizer, an acrylate containing substance, a phenolic substance, and erucamide. These additives can be added to fluid mixture 121 with plastic molten substance to bond with various metals such as aluminum, stainless steel, or tin.

Additives usable in fluid mixture 121 applied to a base component 110 with a metal base material may include, for example, substances comprising ester groups and hydroxyl groups. The ester groups and hydroxyl groups may react with some metals that may be used in the base material to form a chemical bond at the melt temperatures of some plastics usable as the molten substance of fluid mixture. For example, poly(ether-ester) includes ester groups and hydroxyl groups. At the melt temperature of PET, which may be used as the molten substance, poly(ether-ester) may react with aluminum, which may be used as the base material, to form a chemical bond. The chemical bond may include a carbon, oxygen, and aluminum containing compound. Thus, in some embodiments, the additive in fluid mixture 121 may include poly(ether-ester). In some further embodiments, the molten substance may include PET and the base material may include aluminum.

In another example, the additive in fluid mixture 121 may include a slip agent having both a fatty acid ester and either or both of an amine group and a carboxyl group. Such slip agents may react with metals usable as the base material of base component 110, such as aluminum, to create a chemical bond. Temperatures meeting or exceeding the melt temperature for PET or thermoplastic polyolefins such as PP, PE, or PS may be sufficient for such reactions. Accordingly, in some embodiments, fluid mixture 121 may include a slip agent as an additive and PET or a polyolefin as a molten substance. Examples of suitable commercially available slip agents include erucamide, oleamide, stearamide, ethylene bis-oleamide, ethylene bis-stearamide, oleyl palmitamide, sebacic acid, dodecanoic acid.

In a further example, an additive usable in fluid mixture 121 with a molten substance of PET, PVC, or a thermoplastic polyolefin may include an acrylate-containing small molecule substance.

Examples of types of glass suitable for use as the base material include soda-lime glass and borosilicate glass. In a further example, a glass base material may include silica, soda ash (sodium carbonate), and lime (calcium oxide). In some embodiments, the glass may further include alumina.

In embodiments wherein the base material includes glass, the additive included in fluid mixture 121 may include a substance that is reactive with the glass of the base material. In some embodiments, the additive may include a substance that oxidizes the glass of the base material.

In embodiments wherein the base material of base component 110 includes glass, the additive used in fluid mixture 121 may include one or more metal oxides, such as, for example, magnesium oxide, copper oxide, silver oxide, cobalt oxide, nickel oxide, gold oxide, selenium oxide lead oxide, or titanium oxide, salts such as lithium carbonate or cadmium sulfide, or isolated elements capable of bonding to glass such as sulfur or zinc. Thus, in some embodiments, the additive may include at least one from a group consisting of a metal oxide, a salt, and an isolated element capable of bonding to glass. Further possible additives for fluid mixture 121 to be applied to a glass base component 110 include colorants, opacifiers, calcifiers, bleaching agents, foaming agents and other stabilizers. Additives may be selected according to the purpose for which the finished article is to be used. Accordingly, additives such as lead oxide and cadmium sulfide may be excluded from articles intended for food storage.

In some embodiments, the additive included in fluid mixture 121 may be a first additive. The base component 110 may include a second additive integrated into the base material. The second additive may be reactive with the first additive. The second additive may therefore contribute to creating bond layer 111. The second additive may also improve the properties of the base material, such as by contributing to the durability of metal or glass base materials.

In some embodiments wherein the base material includes metal, the second additive may include, for example, carbon, sodium, boron, manganese, chromium, magnesium, phosphorous, or calcium.

In some embodiments wherein the base material is glass, the second additive may include, for example, soda ash, limestone, lime (calcium oxide) or alumina.

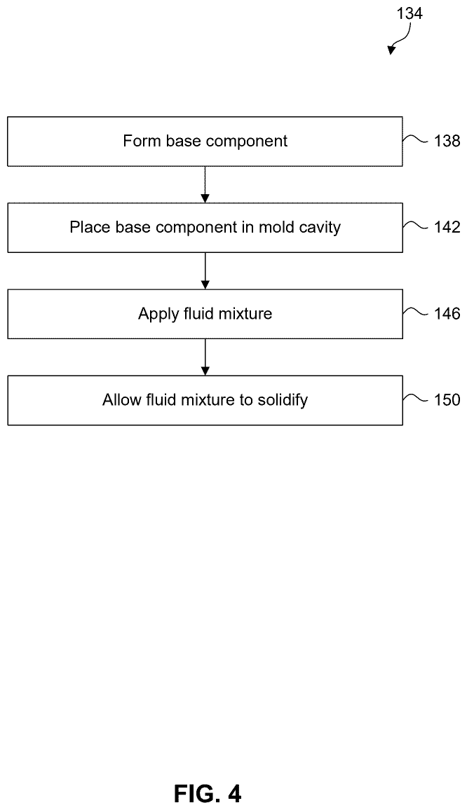

FIG. 4 shows a process 134 for manufacturing composite article 126 as described above. Process 134 includes a forming step 138. Forming step 138 includes forming base component 110. Forming base component 110 may include forming base component 110 of the base material.

Process 134 further includes a placing step 142 after forming step 138. Placing step 142 includes placing base component 110 in mold cavity 118.

Process 134 further includes applying step 146 after placing step 142. Applying step 146 includes applying a fluid mixture 121 to base component 110. Applying step 146 may include forcing fluid mixture 121 into mold cavity 118 through channel 122 while base component 110 remains in mold cavity 118. Fluid mixture 121 may form structure 130 when allowed to solidify.

Thus, in some embodiments, applying step 146 may include injection molding fluid mixture 121 into mold 114 while base component 110 remains within mold 114. In some further embodiments, applying step 146 may include compression molding fluid mixture 121 into mold 114 while base component 110 remains within mold.

Process 134 further includes solidifying step 150 after applying step 146. Solidifying step 150 includes allowing fluid mixture 121 to solidify on base component 110 to create composite article 126. Thus, solidifying step 150 can include allowing fluid mixture 121 to solidify into structure 130.

The additive in fluid mixture 121 may react with the base material during applying step 146. Thus, in some embodiments, applying step 146 may include forming a portion of bond layer 111. In some further embodiments, applying step 146 may include forming an entirety of bond layer 111. In other further embodiments, the additive in fluid mixture 121 may react with the base material during solidifying step 150. Thus, in some embodiments, solidifying step 150 may include forming a portion of bond layer 111.

Structure 130 may take any form that is useful to the purpose of composite article 126. The form and function of structure 130 may therefore vary widely depending on the type of composite article 126 to be created. For example, in some composite articles 126, structure 130 may have a shape that is difficult or inefficient to form from the base material, such as threading. In another example, in some composite articles 126, structure 130 may be used to provide properties that the base material lacks, such as by providing barrier properties when composite article 126 is intended for contact with a substance safe for contact with the base material but not safe for contact with the material of structure 130, or by providing resilience when the base material is fragile. For example, when composite article 126 is intended for storing food, the base material may be a food safe substance such as glass or certain types of metal and structure 130 may be formed on an outside of base component 110 from material that is not intended for prolonged, direct contact with food. In another example, the base material may be a brittle material such as glass or certain types of metal, and structure 130 may be formed as a coating on base component 110 from relatively resilient material to reinforce base component 110.

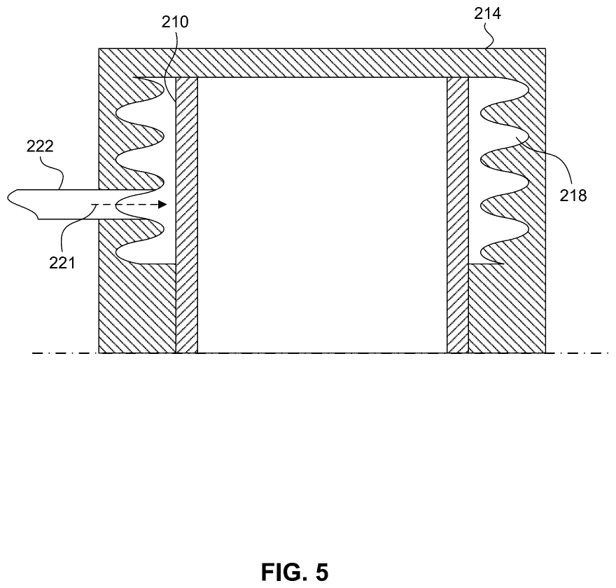

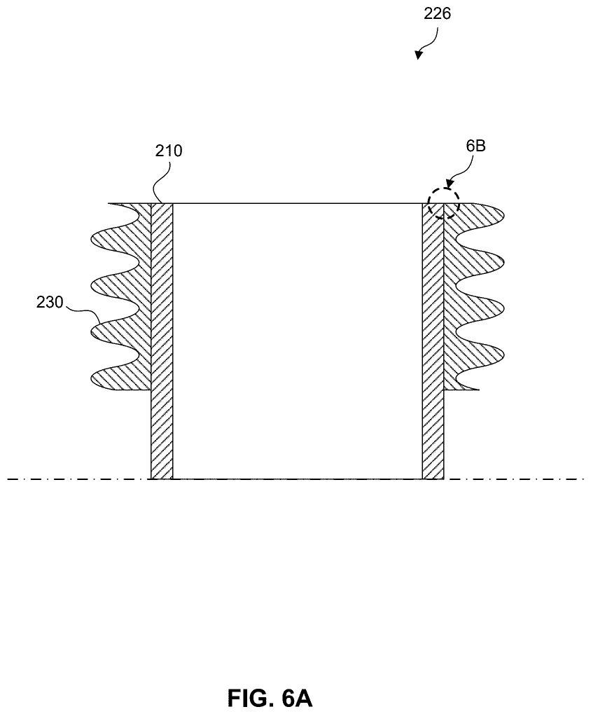

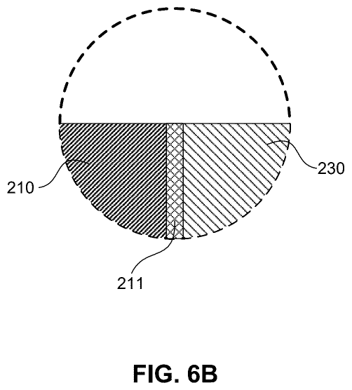

FIG. 5 illustrates a base component 210 and mold 214 usable to create a composite article 226 having a threaded structure 230 shown in FIGS. 6A and 6B. In FIGS. 5-7, numerals in the 200 series are used to indicate like numbered elements labeled in FIGS. 2, 3A, and 3B with numerals in the 100 series. Accordingly, base component 210 is alike to base component 110, mold 214 is alike to mold 114, and so on, and all description of elements labeled with numerals in the 100 series apply equally to like numbered elements labeled with numerals in the 200 series.

As shown in FIG. 5, mold 214 defines mold cavity 218. Base component 210 is disposed in mold cavity 218. Base component 210 and mold 214 are both shown schematically and in cross-section. A channel 222 is in fluid communication with mold cavity 218 such that substances may be forced into mold cavity 218 through channel 222.

Mold cavity 218 is shaped as a negative of a threaded structure 230. Thus, when fluid mixture 221 is applied to base component 210 by forcing fluid mixture 221 into mold cavity 218 through channel 222, fluid mixture 221 will fill mold cavity 218 and assume a threaded shape.

Allowing fluid mixture 221 to solidify upon base component 210 in mold cavity 218 forms a composite article 226 including a threaded structure 230 as shown in FIGS. 6A and 6B. Thus, a threaded structure 230 may be formed on base component 210 without forming threads from the base material. This can be advantageous in applications where forming threads from the base material would be difficult or inefficient. For example, in some processes for forming metal bottles for storing beverages, forming threads from the metal of the bottle creates a substantial proportion of the difficulty and expense of the entire process. While some steps in these metal bottle manufacturing processes can be performed with readily available canning equipment, metal threading requires its own tooling. Molding a plastic threaded structure onto a metal vessel may be significantly less difficult and expensive than creating threads from the metal while using only a fraction of the plastic needed to construct a bottle entirely from plastic. In some embodiments, a composite container or composite bottle with threads so formed may then be filled and capped in existing facilities previously used for plastic bottling, further reducing costs and improving efficiency compared to all-metal bottling. Thus, by applying a small amount of plastic only where needed, difficulties associated with current all-metal packaging processes can be avoided, leading to an immediate and significant reduction in total plastic usage with minimal expense.

As also shown in FIG. 6B, an additive in fluid mixture 221 can react with the base material in base component 210 to create a bond layer 211, similar to bond layer 111 described above. In some embodiments, bond layer 211 may form on a majority of a surface area of base component 210 contacted by fluid mixture 221. In some embodiments, bond layer 211 may form on an entirety of a surface area of base component 210 contacted by fluid mixture 221. The threaded structure 230 can therefore be securely attached to base component 210 within composite article 226 without the need to form interlocking structures on base component 210, further reducing costs and improving efficiency.

Composite article 226 may be a composite container. For example, composite article 226 may be a composite bottle.

In further embodiments, structure 230 may include a fitment, such as a fitment for a bottle. In some such embodiments, the fitment may be a fitment with a lip. In further embodiments, the fitment may be a threaded fitment. Thus, in some embodiments, a cap may be assembled onto the fitment.

In further embodiments, structure 230 may include a finish, such as a finish for a bottle. In some embodiments, the finish may be a threaded finish. In further embodiments, the finish may be a finish with a lip. Thus, in some embodiments, a cap may be assembled onto the finish.

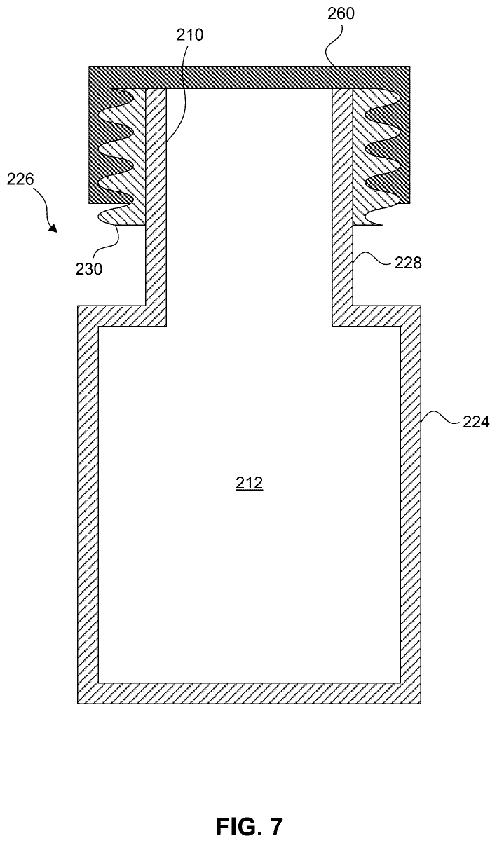

FIG. 7 shows composite article 226 in the form of a closed bottle. Base component 210 may include a vessel defining an interior space 212. Interior space 212 may be enclosed by composite article 226. A closure 260, such as a cap, may be threadedly engaged with structure 230 to close off interior space 212.

Base component 210 may optionally include a body 224 and a neck 228. Neck 228 may be narrower than body 224. Some users may find a relatively narrow neck 228 preferable to drink from or to make closure 260 easier to handle. Thus, in some embodiments wherein base component 210 is a metal vessel, a process of forming base component 210 may include first drawing a piece of metal into a shape similar to a body of a common beverage can, then rolling an open end of the drawn piece of metal to a smaller diameter to create a distinct body 224 and neck 228. However, in other embodiments, base component 210 can have a constant, or at least substantially constant, width and therefore lack a distinct body 224 and neck 228.

The base material of base component 210 in the embodiment of FIGS. 5-7 need not be metal. However, a threaded structure 230 can have certain advantages at least in embodiments where the base material is metal as described above.

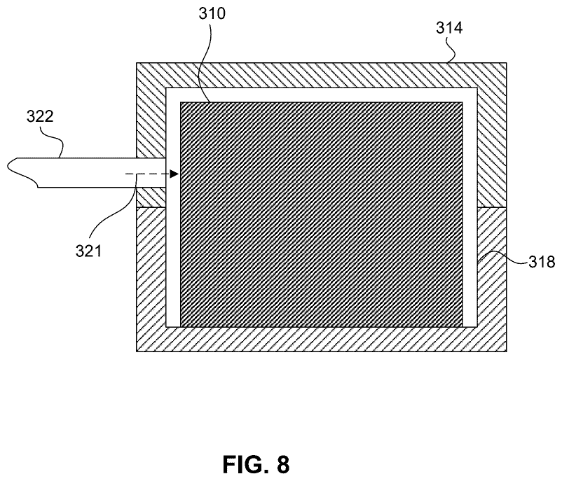

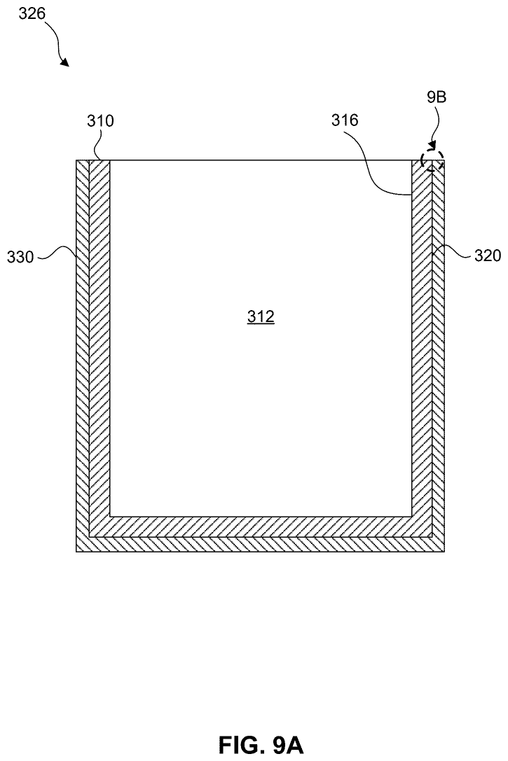

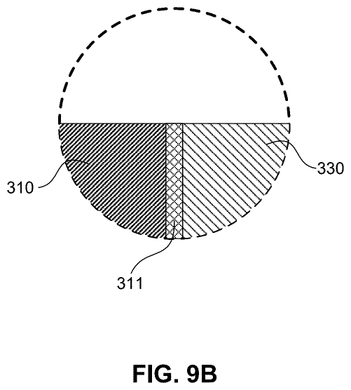

FIG. 8 illustrates a base component 310 and mold 314 usable to create a composite article 326 having a coating structure 330 shown in FIGS. 9A and 9B. In FIGS. 8-10, numerals in the 300 series are used to indicate like numbered elements labeled in FIGS. 2, 3A, and 3B with numerals in the 100 series and like elements labeled in FIGS. 5-7 with numerals in the 200 series. Accordingly, base component 310 is alike to base components 110, 210, mold 314 is alike to molds 114, 214, and so on, and all description of elements labeled with numerals in the 100 series or 200 series apply equally to like numbered elements labeled with numerals in the 200 series.

As shown in FIG. 8, mold 314 defines mold cavity 318. Base component 310 is disposed in mold cavity 318. Base component 310 and mold 314 are both shown schematically and in cross-section. A channel 322 is in fluid communication with mold cavity 318 such that substances may be forced into mold cavity 318 through channel 322.

Mold 314 may provide a relatively thin clearance between a surface of base component 310 and a surface of mold cavity 318. Thus, when fluid mixture 321 is applied to base component 310 by forcing fluid mixture 321 into mold cavity 318 through channel 322, fluid mixture 321 will fill mold cavity 318 as a coating upon base component 310.

Allowing fluid mixture 321 to solidify upon base component 310 in mold cavity 318 forms a composite article 326 including a coating structure 330 as shown in FIG. 9A. The thickness of coating structure 330 relative to base component 310 may vary according to the type of base material used, the composition of fluid mixture 321, and the form and purpose of composite article 326. In some embodiments, the thickness of coating structure 330 may be, for example, from 0.5% to 10% of the thickness of base component 310 at the same location, from 2% to 8% of the thickness of base component 310 at the same location, or from 4% to 6% of the thickness of base component 310 at the same location. Coating structure 330 thicknesses in the foregoing ranges may be used, for example, where the base material includes glass. Coating structure 330 thicknesses in the foregoing ranges may also be used where composite article 326 is a container.

By applying a relatively thin coating structure 330, structure 330 may provide useful properties of plastic to composite article 326 as a whole without plastic making up any significant proportion of the total weight of composite article 326.

For example, where the base material of base component 310 includes glass, structure 330 may provide some resilience and shatter resistance to composite article 326. In some further examples, structure 330 can also provide useful barrier properties to composite article 326.

As also shown in FIG. 9A, an additive in fluid mixture 321 can react with the base material in base component 310 to create a bond layer 311, similar to bond layer 311 described above. In some embodiments, bond layer 311 may form on a majority of a surface area of base component 310 contacted by fluid mixture 321. In some embodiments, bond layer 311 may form on an entirety of a surface area of base component 310 contacted by fluid mixture 321. The coating structure 330 can therefore be securely attached to base component 310 within composite article 326 without the need to form interlocking structures on base component 310. An outer surface 320 of base component 310 may therefore be designed to prioritize other objectives, such as to create a desired appearance or to improve cost efficiency.

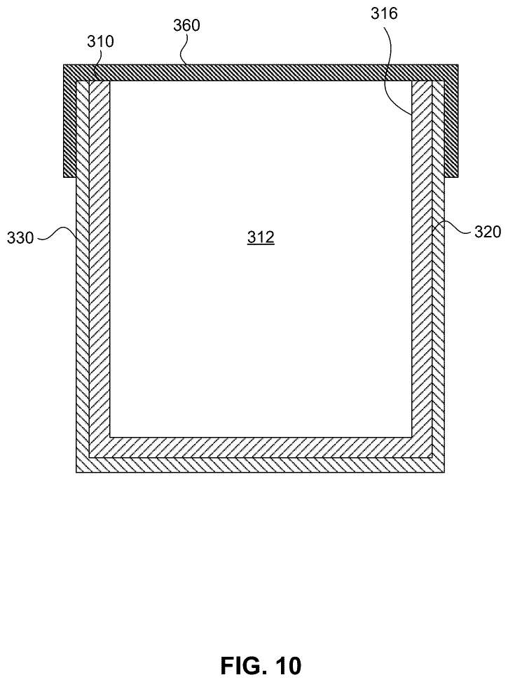

The amount of outer surface 320 covered by structure 330 may vary in different embodiments. In some embodiments, outer surface 320 may be entirely covered by structure 330. In further embodiments, from 50% to 100% of the area of outer surface 320 may be covered by structure. In further embodiments, structure 330 may be limited to sidewalls of base component 310 and excluded from a base or supporting surface of base component 310. In further embodiments, structure 330 may be limited to a base or supporting surface of base component 310 and excluded from sidewalls of base component 310. In further embodiments, structure 330 may be excluded from structures in base component 310 configured to engage a closure 360, which is described further below with respect to FIG. 10. For example, threading may be formed in outer surface 320 of base component 310, and structure 330 may be excluded from the threading.

Composite article 326 may be a composite container. For example, composite article 326 may be a composite jar.

In some further examples, the application of structure 330 may apply compression to base component 310, thereby cooperating with glass's relatively great strength under compression and offsetting glass's relatively low strength under tension to improve the overall durability of composite article 326. Thus, in some embodiments, applying fluid mixture 321 to base component 310 may include compressing the base material of base component 310 vessel by application of fluid mixture 321. For example, fluid mixture 321 may be injected with 50 to 1000 tons of force. The injection force may compress base component 310. After fluid mixture 321 solidifies into structure 330, structure 330 may maintain some of the compression of base component 310.

Thus, the addition of structure 330 may enable composite article 326 to have similar overall durability to all-glass containers with as much as 50% greater weight for the same storage capacity. In some such embodiments, no more that 1.0% of composite article 326 by weight may include plastic.

The lower weight of composite article 326 than an all-glass container the same storage capacity can create both environmental benefits and cost savings during distribution. Vehicles used for transporting goods have both a volume limit and a weight limit on how much can be transported in a single load. A load of products in all-glass containers will often reach the weight limit for a vehicle while falling far short of the volume limit. This creates inefficiencies in distribution because it places a relatively low limit on the number of products that can be carried in a single load and because most vehicles are least fuel efficient when loaded to their weight limit. Using a composite article 326 as a container can therefore improve fuel efficiency and reduce the total number of loads needed to transport a given number of products, leading to cost savings and environmental benefits that outweigh the use of a small amount of plastic to create structure 330.

Base component 310 may define an interior space 312. Base component 310 may include an outer surface 320 that faces away from interior space. Base component 310 may also include an inner surface 316 that defines the interior space. For example, in some embodiments, base component 310 may include a concavity that defines interior space 312 by enclosing interior space 312. Inner surface 316 may therefore have a concave shape. Outer surface 320 may similarly have a convex shape.

In some embodiments, forming structure 330 may include applying fluid mixture 321 to outer surface 320. In some further embodiments, creating composite article 326 may include keeping inner surface 316 of base component 310 of fluid mixture 321 and structure 330 such that no portion of structure 330 adjoins interior space 312 in the completed composite article 326. Thus, in some embodiments, inner surface 316 of base component 310 may be free of any bond layer 311 and structure 330. In some further embodiments, creating composite article 326 may comprise causing fluid mixture 321 to spread across and solidify upon a majority of outer surface 320. In some further embodiments, creating composite article 326 may comprise causing fluid mixture 321 to spread across and solidify upon at least 75% of outer surface 320. In some further embodiments, creating composite article 326 may comprise causing fluid mixture 321 to spread across and solidify upon at least 90% of outer surface 320. In some further embodiments, creating composite article 326 may comprise causing fluid mixture 321 to spread across and solidify upon an entirety of outer surface 320.

By keeping inner surface 316 free of structure 330, composite article 326 can have some of the useful properties associated with plastic without any plastic coming into contact with the contents of interior space 312. Composite article 326 may therefore be useful as a container for foods that are preferably stored in glass. The addition of a plastic coating by way of structure 330 may enable composite article 326 to be strong and durable at a relatively light weight while the food stored in composite article 326 only contacts the glass base material of base component 310. Further, the addition of a plastic coating may have little impact on the recyclability of some varieties of glass. Some glass recycling processes include melting the glass to be recycled. Some glasses have high enough melt temperatures that plastic or other materials usable for structure 330 may burn off during the melt, leaving negligible impurities, if any, in the melted glass. Composite article 326 according to some embodiments may therefore be less economically and environmentally burdensome to distribute than comparable all-glass containers while using less total material and being no more difficult to recycle.

Composite article 326 can be particularly useful as a reusable container, such as a reusable food container. One limitation plastic faces as a material for reusable containers is the tendency for certain plastics to absorb portions of substances it contacts. Further, certain plastics'reactivity and relatively low tolerance to heat can make thorough cleaning and sanitizing of used plastic containers difficult. As a result, plastic containers can be difficult to restore to a like-new state. For example, plastic food containers may absorb some flavors from stored food, which could then affect later stored foods if the plastic food containers are reused. A non-absorbent and non-reactive base material, such as glass, can be used for base component 310 so that the contents of composite article 326 make no change to base component 310 after prolonged or repeated uses. Composite article 326 may therefore be restorable to like-new condition even after several uses.

FIG. 10 shows composite article 326 in the form of a closed jar. Interior space 312 may be enclosed by composite article 326. A closure 360, such as a cap, may be engaged with an open end of base component 310 or structure 330 to close off interior space 312. Composite article 326 may have a cooperating feature for engaging closure 360, such as a lip or threading. The cooperating feature may be similar in shape to cooperating features of existing glass jars. In some examples, the cooperating feature may be formed in base component 310. To enable the cooperating feature to engage closure 360, structure 330 may be absent from the portion of base component 310 that forms the cooperating feature, or structure 330 may follow the shape of base component 310 to create a further part of the cooperating feature. In further embodiments, the cooperating feature may be formed entirely by structure 330.

The base material of base component 310 in the embodiment of FIGS. 5A-7 need not be glass. However, a coating structure 330 can have certain advantages at least in embodiments where the base material is glass as described above.

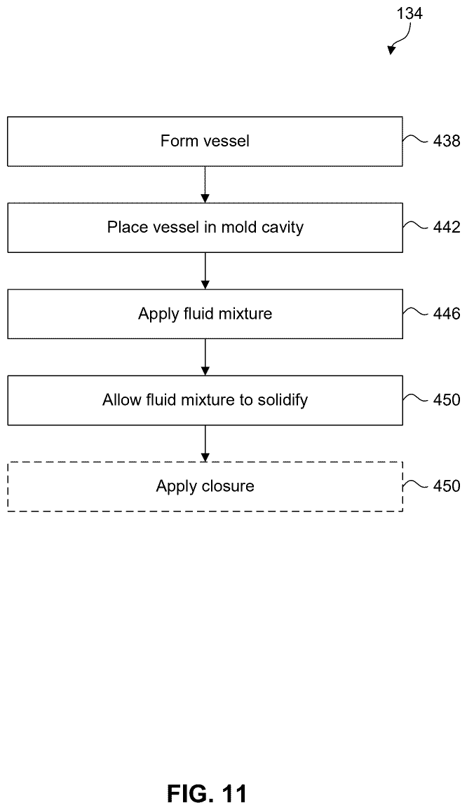

FIG. 11 illustrates a base process 434 for producing a composite container such as the bottle of FIG. 7 or the jar of FIG. 10. In FIG. 11, numerals in the 400 series are used to indicate like numbered elements labeled in FIG. 4 with numerals in the 100. Accordingly, forming step 438, placing step 442, applying step 446, and solidifying step 450 are alike to forming step 138, placing step 142, applying step 146, and solidifying step 150, respectively. In process 434, the base component is a vessel defining an interior space. Process 434 may optionally further include a closing step 454 following solidifying step 450. Closing step 454 may include applying a closure to an open end of the composite container to close off the interior space.

It is to be appreciated that the Detailed Description section, and not the Summary and Abstract sections, is intended to be used to interpret the claims. The Summary and Abstract sections may set forth one or more but not all exemplary embodiments of the present disclosure but are not intended to limit the present disclosure and claims in any way.

The foregoing description of the specific embodiments so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the claims and their equivalents.

What is claimed is:

1. A method of manufacturing a bottle, the method comprising:
forming a vessel of metal; and
forming a structure on the vessel by applying a fluid mixture to the vessel, wherein the fluid mixture comprises a molten substance and an additive, wherein the molten substance is a plastic and the additive is reactive with the metal such that the additive reacts with the metal to form a bond layer joining the structure to the vessel.

2. The method of claim 1, wherein the structure comprises a threaded fitment.

3. The method of claim 2, comprising assembling a cap onto the fitment.

4. The method of claim 1, wherein the bond layer is formed across an entirety of a surface area of the vessel contacted by the fluid mixture.

5. The method of claim 1, comprising applying the fluid mixture to the vessel at a temperature and pressure sufficient to initiate a chemical reaction between the additive and the metal.

6. The method of claim 5, wherein the chemical reaction comprises oxidation of the metal.

7. The method of claim 5, wherein the chemical reaction creates a chemical bond between the structure and the vessel.

8. The method of claim 1, wherein the additive comprises a substance selected from a group consisting of a hydroxyl group containing compound, carboxylic acid, a hindered amine light stabilizer, an acrylate containing substance, a phenolic substance, and erucamide.

9. A method of manufacturing a composite container, the method comprising:
forming a vessel of glass, wherein the vessel defines an interior space and comprises an outer surface that faces away from the interior space; and
forming a coating on the vessel by applying a fluid mixture to the outer surface, wherein the fluid mixture comprises a molten substance and an additive, wherein the molten substance is a plastic and the additive is reactive with the glass such that the additive reacts with the metal to form a bond layer joining the coating to the vessel.

10. The method of claim 9, wherein the glass comprises silica, soda ash, lime and alumina.

11. The method of claim 9, comprising applying the fluid mixture to the vessel at a temperature and pressure sufficient to initiate a chemical reaction between the additive and the glass.

12. The method of 11, wherein the chemical reaction comprises oxidation of the glass.

13. The method of claim 11, wherein the chemical reaction creates a chemical bond between the structure and the vessel.

14. The method of claim 9, wherein the additive comprises a substance selected from a group consisting of a metal oxide, a salt, and an isolated element capable of bonding to glass.

15. The method of claim 9, comprising causing the fluid mixture to spread across and solidify upon a majority of the outer surface to create the composite container.

16. The method of claim 15, wherein no more than 1.0% of the composite container by weight comprises plastic.

17. The method of claim 9, wherein applying the fluid mixture to the vessel comprises compressing the glass of the vessel by application of the fluid mixture.

18. The method of claim 9, wherein the vessel comprises an inner surface that defines the interior space, and wherein the method comprises:
allowing the fluid mixture to solidify on the vessel to create the composite container; and
keeping the inner surface of the vessel free of the fluid mixture and coating such that no portion of the coating adjoins the interior space in the composite container.

19. The method of claim 18, wherein the additive is a first additive, and wherein the vessel comprises a second additive integrated into the glass, the second additive being reactive with the first additive.

20. A composite article comprising:
a vessel formed of a base material, wherein the base material is metal or glass;
a structure formed on the vessel, wherein the structure comprises plastic; and
a bond layer joining the structure to the vessel, wherein the bond layer comprises a product of a chemical reaction between the base material and a substance comprised by the structure.

21. The composite article of claim 20, wherein the product of the chemical reaction comprises an oxide of the base material.

22. The composite article of claim 20, wherein the substance is an additive selected from:
a group consisting of a hydroxyl group containing compound, carboxylic acid, a hindered amine light stabilizer, an acrylate containing substance, a phenolic substance, and erucamide, or a group consisting of a metal oxide, a salt, and an isolated element capable of bonding to glass.

23. The composite of claim 20, wherein the vessel is a metal bottle.

24. The composite of claim 20, wherein the vessel is a glass jar.
